(19) United States
(12) Patent Application Publication
(10) Pub. No.: US 2026/0148917 A1
(43) Pub. Date: May 28, 2026

(54) ANTI-RESET OVERHEAT PROTECTOR

(71) Applicant: AuOne ELECTRONIC MANUFACTURING LIMITED, Foshan (CN)

(72) Inventors: Hehua LI, Foshan (CN); Chi Man AO, Foshan (CN); Runeng CHEN, Foshan (CN)

(21) Appl. No.: 19/014,281

(22) Filed: Jan. 9, 2025

(30) Foreign Application Priority Data
Nov. 28, 2024 (CN) 2024117261074

(51) Int. Cl. H01H 37/00; H01H 37/54

(52) U.S. Cl. CPC H01H 37/002; H01H 37/5409

(57) ABSTRACT

An anti-reset overheat protector comprising a base; the base is provided with a first power connection end, a second power connection end, a reed and a temperature sensing piece; a first end of the reed is fixedly connected to the first power connection end, and the temperature sensing piece is arranged above the reed; the temperature sensing piece is exposed so that the sensitivity to the ambient temperature is improved; when the temperature reaches a critical value, the temperature sensing piece propels the reed to disconnect from the second power connection end such that the circuit is cut off; the deformation of the temperature sensing piece enables the reed to jump to the anti-reset structure and is connected to the anti-reset structure in an interacting mode; the temperature sensing piece is prevented from being deformed again to reset the reed, so that a one-time overheat protection function is achieved.

### TECHNICAL FIELD

This invention generally relates to the technical field of temperature control, and more particularly, to an anti-reset overheat protector.

### BACKGROUND

A temperature controller refers to a series of automatic control elements that physically deform inside a switch according to the temperature variation of the operating environment to achieve the turning-on/off of the circuit. Its operating principle is to automatically sample and monitor the ambient temperature in real time through a temperature sensing component and then turn on/off a control circuit when the ambient temperature is higher than a set control value. A snap-action temperature controller is a contact-type temperature sensor, which needs to be installed on the surface of a heating body to conduct heat to a temperature sensing bimetallic strip through a housing or a heat conduction element. When the temperature reaches the critical value of the temperature sensing bimetallic strip, the temperature sensing bimetallic strip deforms to turn on/off the circuit.

Further, when the temperature cannot be effectively controlled, to prevent the equipment from being damaged, a fuse protector may be connected in series on the control circuit for cutting off the circuit, or an additional fuse element may be arranged on the temperature controller. In this way, when the temperature exceeds the fusion point, the fuse element directly cuts off the internal circuit of the temperature controller, and the control circuit cannot be turned on again. Thus, the one-time overheat protection is achieved.

Chinese patent CN202601519U discloses a temperature control fuse protector, comprising a first cylindrical housing, a fuse protection structure, a first wire, a second rectangular housing, a temperature control protection structure and a second wire, wherein the first housing wraps the fuse protection structure by means of epoxy resin and paraffin arranged at the top of the first housing. The first wire is connected to one end of the fuse protection structure, the fuse protection structure wraps the second housing, and the second housing wraps the temperature control protection structure. The other end of the fuse protection structure is connected to a non-wire connection end of the temperature control protection structure, and a wire connection end of the temperature control protection structure is connected to the second wire.

The aforesaid temperature control fuse protector integrates the functions of temperature control and fusing, so that the layout of the circuit control components is relatively compact, and the temperature control circuit is capable of being cut off when the temperature control fails. However, the fuse protection structure adopts a fuse wire and cannot be repeatedly used after being fused, resulting in the simultaneous damage of the temperature controller and high use cost.

For some scenarios that require monitoring of the ambient temperature, the thermal response speed of conventional contact-type temperature controllers is low and the response is late.

Therefore, it is urgent for those skilled in the art to develop a novel overheat protector.

### SUMMARY

The purpose of the present invention is to provide an anti-reset overheat protector, which has a reasonable structure, has a quick response to ambient temperature, achieves the one-time overheat protection and is capable of being repeatedly used.

To achieve the above purpose, the present invention adopts the following technical solution: an anti-reset overheat protector of the present invention comprises a base, wherein the base is provided with a first power connection end, a second power connection end, a reed and a temperature sensing piece; a first end of the reed is fixedly connected to the first power connection end, and a second end of the reed is paired with the second power connection end; the temperature sensing piece is arranged above the reed; a first end of the temperature sensing piece is connected to the first power connection end in an interacting mode, and a second end of the temperature sensing piece is connected to the second end of the reed in an interacting mode; an anti-reset structure is arranged on the base, and the anti-reset structure is connected to the second end of the reed in an interacting mode.

In another embodiment of the present invention, the anti-reset structure comprises an anti-reset elastic piece, and the anti-reset elastic piece is arranged on one side of the second end of the temperature sensing piece. A first end of the anti-reset elastic piece is fixedly connected to the base, and a second end of the anti-reset elastic piece is provided with a limiting hook. The second end of the reed abuts against the limiting hook. When the temperature sensing piece deforms, the limiting hook is propelled to move towards the anti-reset elastic piece, so that the second end of the reed goes over the limiting hook and is hooked on the limiting hook.

In another embodiment of the present invention, the limiting hook and the anti-reset elastic piece are configured to be an integrally-bent structure. The limiting hook and the anti-reset elastic piece form a V-shaped deformable structure. When the temperature sensing piece deforms, the limiting hook is propelled to deform towards the anti-reset elastic piece, so that the second end of the reed is hooked on the limiting hook.

In another embodiment of the present invention, the base is provided with a support plate, and the support plate is arranged opposite to the second end of the reed. The anti-reset elastic piece is attached to the support plate, so that the limiting hook and the reed are connected in an interacting mode.

In another embodiment of the present invention, the overheat protector comprises a holder, and a first end of the holder is fixedly connected to the base. The holder is arranged above the temperature sensing piece, and a second end of the holder is fixedly connected to the support plate. The first end of the anti-reset elastic piece is provided with a fixing member, and the fixing member is fixedly connected to the holder, thereby allowing the anti-reset elastic piece to be attached to the support plate.

In another embodiment of the present invention, the holder is provided with a hollowed-out groove.

In another embodiment of the present invention, the overheat protector further comprises a special tool, and a connecting portion between the support plate and the holder is provided with a reset groove. The special tool is capable of penetrating through the reset groove to pull the limiting hook to move towards the anti-reset elastic piece.

In another embodiment of the present invention, the first power connection end and the holder are riveted to a first end of the base through a first rivet, and a second end of the base is provided with a stationary contact. The stationary contact and the second power connection end are riveted by a second rivet, and the second end of the reed is provided with a movable contact. The movable contact and the stationary contact are arranged up and down in a paired manner.

In another embodiment of the present invention, the overheat protector comprises a housing. The housing covers a bottom surface, a left end surface, a right end surface, a front side surface and a rear side surface of the base. An upper end of the housing is provided with an opening, and the first power connection end and the second power connection end respectively penetrate through a left end wall and a right end wall of the housing.

In another embodiment of the present invention, the first end of the anti-reset elastic piece is provided with the fixing member, the second end of the base is provided with a socket, and the socket is provided with a fastener connected to the socket in a paired manner. The fixing member is arranged between the fastener and the socket in a penetrating manner, and the fastener is connected to the socket in a paired manner for fixing the anti-reset elastic piece on the socket.

Compared with the prior art, the present invention has the following advantages: the structure is reasonable; the first power connection end, the reed and the second power connection end are sequentially electrically connected; the temperature sensing piece is arranged in an exposed mode so that the sensitivity to the ambient temperature is significantly improved; when the temperature reaches a critical value, the temperature sensing piece propels the reed to disconnect from the second power connection end such that the circuit is cut off; the deformation of the temperature sensing piece enables the reed to jump to the anti-reset structure and is connected to the anti-reset structure in an interacting mode; the temperature sensing piece is prevented from being deformed again to reset the reed, so that a one-time overheat protection function is achieved.

### BRIEF DESCRIPTION OF THE DRAWINGS

FIG. 1 is a schematic diagram illustrating a sectional view of the overheat protector in embodiment 1 of the present invention;

FIG. 2 is a schematic diagram illustrating the interaction between the deformed temperature sensing piece and the anti-reset elastic piece in embodiment 1 of the present invention;

FIG. 3 is a schematic diagram illustrating a sectional view of the overheat protector in embodiment 2 of the present invention; and

FIG. 4 is a schematic diagram illustrating the interaction between the deformed temperature sensing piece and the anti-reset elastic piece in embodiment 2 of the present invention;

In Figures: 1—Base, 2—Reed, 3—Anti-reset Elastic Piece, 4—Support Plate, 5—Special Tool, 11—The First Power Connection End, 12—The Second Power Connection End, 13—The First Rivet, 14—Stationary Contact, 15—The Second Rivet, 16—Housing, 17—Socket, 18—Fastener, 21—Temperature Sensing Piece, 22—Movable Contact, 31—Limiting Hook, 32—Fixing Member, 41—Holder, 42—Hollowed-out Groove, 43—Reset Groove.

### DETAILED DESCRIPTION

Drawings and embodiments are combined hereinafter to further elaborate the technical solution of the present invention.

### Embodiment 1

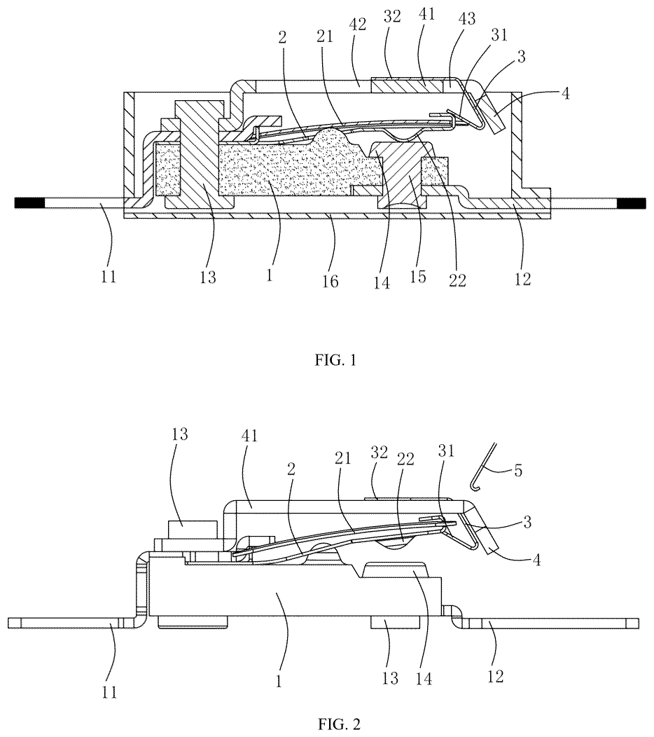

As shown in FIGS. 1-2, the anti-reset overheat protector of the present invention comprises a base 1, wherein the base 1 is provided with a first power connection end 11, a second power connection end 12, a reed 2 and a temperature sensing piece 21. A first end of the reed 2 is fixedly connected to the first power connection end 11, and a second end of the reed 2 is paired with the second power connection end 12. The temperature sensing piece 21 is arranged above the reed 2. A first end of the temperature sensing piece 21 is connected to the first power connection end 11 in an interacting mode, and a second end of the temperature sensing piece 21 is connected to the second end of the reed 2 in an interacting mode. An anti-reset structure is arranged on the base 1, and the anti-reset structure is connected to the second end of the reed 2 in an interacting mode. The base 1, the first power connection end 11, the reed 2 and the second power connection end 12 form the main structure of the present invention. The first power connection end 11 and the second power connection end 12 are connected to a control circuit, and the second end of the reed 2 is capable of interacting with the second power connection end 12 to achieve the on-off of the control circuit.

Preferably, the temperature sensing piece 21 is exposed to the environment, thereby achieving a quick response to the temperature variation. When the temperature exceeds a critical value, the temperature sensing piece 21 rapidly deforms to propel the second end of the reed 2, so that the second end of the reed 2 is separated from the second power connection end 12. After the temperature sensing piece 21 is heated and deforms, the first end of the temperature sensing piece 21 is connected to the first power connection end 11. Based on this, the temperature sensing piece 21 integrally warps, thereby enabling the second end of the temperature sensing piece 21 to turn over upwards. In this way, the second end of the reed 2 is hooked on the anti-reset structure to form a connection in an interacting mode.

Further, after the temperature sensing piece 21 begins to cool down, the temperature sensing piece 21 deforms again. However, at this point, the second end of the reed 2 is connected to the anti-reset structure, and the anti-reset structure is capable of preventing the reed 2 from being reset, thereby realizing the one-time overheat protection. The thermal deformation principle of the temperature sensing piece 21 is the same as that of the conventional bimetallic strip/memory metal and is therefore briefly described herein.

The anti-reset structure comprises an anti-reset elastic piece 3, and the anti-reset elastic piece 3 is arranged on one side of the second end of the temperature sensing piece 21. A first end of the anti-reset elastic piece 3 is fixedly connected to the base 1, and a second end of the anti-reset elastic piece 3 is provided with a limiting hook 31. The second end of the reed 2 abuts against the limiting hook 31. When the temperature sensing piece 21 deforms, the limiting hook 31 is propelled to move towards the anti-reset elastic piece 3, so that the second end of the reed 2 goes over the limiting hook 31 and is hooked on the limiting hook 31. The anti-reset elastic piece 3 is configured to mount the limiting hook 31 on one side of the second end of the reed 2, thereby allowing the limiting hook 31 and the reed 2 to be arranged opposite to each other.

The limiting hook 31 possesses a tendency of moving towards the anti-reset elastic sheet 3, and the action of the limiting hook 31 needs an external force. Certainly, the limiting hook 31 may also return to an initial state when the external force does not exist. More specifically, the heat deformation of the temperature sensing piece 21 leads to a sudden kick action. The first end of the temperature sensing piece 21 is limited by the first power connection end 11, and the temperature sensing piece 21 deforms in a recurved mode. Thus, the second end of the temperature sensing piece 21 tilts upwards, thereby propelling the second end of the reed 2 to push the limiting hook 31 from below. In this way, the limiting hook 31 moves towards the anti-reset elastic piece 3, and the reed 2 goes over an end portion of the limiting hook 31 and is separated from the limiting hook 31. Subsequently, the limiting hook 31 returns to the initial position, the end portion of the limiting hook 31 abuts against the reed 2 to prevent it from being reset downwards, and the second end of the reed 2 is kept disconnected from the second power connection end 12. Thus, the purpose of the one-time overheat protection is achieved.

The limiting hook 31 and the anti-reset elastic piece 3 are configured to be an integrally-bent structure. Moreover, the limiting hook 31 and the anti-reset elastic piece 3 form a V-shaped deformable structure. When the temperature sensing piece 21 deforms, the limiting hook 31 is propelled to deform towards the anti-reset elastic piece 3, so that the second end of the reed 2 is hooked on the limiting hook 31. As described above, the limiting hook 31 and the anti-reset elastic piece 3 are arranged in a “V” shape, so that the limiting hook 31 is capable of moving towards the anti-reset elastic piece 3 and returning by itself when the external force disappears. More specifically, the limiting hook 31 and the anti-reset elastic piece 3 are processed into the V-shaped structure through a bending process. The structure has high elasticity, which allows the acting force generated by the deformation of the temperature sensing piece 21 to overcome the yield strength of the V-shaped structure. Thus, the limiting hook 31 possesses a tendency of moving towards the anti-reset elastic piece 3. Namely, the opening of the V-shaped structure tends to be closed, which enables the second end of the reed 2 to go over the end portion of the limiting hook 31. It can be understood that, when the temperature sensing piece 21 is heated and deforms to propel the second end of the reed 2, the action of the second end of the reed 2 is equivalent to jumping over the end portion of the limiting hook 31. After the limiting hook 31 returns, the limiting hook 31 pushes the reed 2 up, so that the second end of the temperature sensing piece 21 and the reed 2 are away from the second power connection end 12. Even if the temperature sensing piece 21 deforms again after being cooled, the temperature sensing piece 21 is supported by the limiting hook 31, thus enabling the reed 2 to be away from the second power connection end 12.

The base 1 is provided with a support plate 4, and the support plate 4 is arranged opposite to the second end of the reed 2. The anti-reset elastic piece 3 is attached to the support plate 4, so that the limiting hook 31 and the reed 2 are connected in an interacting mode. The support plate 4 is configured to support the anti-reset elastic piece 3, thereby enabling the limiting hook 31 to move towards the anti-reset elastic piece 3 under the acting force.

Further, the overheat protector comprises a holder 41, and a first end of the holder 41 is fixedly connected to the base 1. The holder 41 is arranged above the temperature sensing piece 21, and a second end of the holder 41 is fixedly connected to the support plate 4. The first end of the anti-reset elastic piece 3 is provided with a fixing member 32, and the fixing member 32 is fixedly connected to the holder 41, thereby allowing the anti-reset elastic piece 3 to be attached to the support plate 4. Preferably, the holder 41 is arranged above the temperature sensing piece 21 and is spaced from the temperature sensing piece 21. The first end of the holder 41 is fixed on the base 1, so that a space for allowing the temperature sensing piece 21 to deform is reserved between the holder 41 and the base 1. Specifically, the holder 41 may be provided with a mounting position for enabling the fixing member 32 to be mounted on the holder 41 by means of insertion, screws and buckles, etc.

As described above, the temperature sensing piece 21 is arranged in an exposed mode, which makes the temperature sensing piece 21 more sensitive to the variation of the ambient temperature such that a high sensitivity is achieved. Further, the holder 41 is provided with a hollowed-out groove 42, and the hollowed-out groove 42 leaves a space for allowing the hot air in the environment to easily flow through the temperature sensing piece 21, so that the high sensitivity of the temperature sensing piece 21 is ensured.

The overheat protector further comprises a special tool 5, and a connecting portion between the support plate 4 and the holder 41 is provided with a reset groove 43. The special tool 5 is capable of penetrating through the reset groove 43 to pull the limiting hook 31 to move towards the anti-reset elastic piece 3. Further, the special tool 5 is provided with a hook portion, and after the maintenance is completed, the special tool 5 may be inserted into the reset groove 43 for hooking the limiting hook 31. When the special tool 5 pulls the limiting hook 31 to move towards the anti-reset elastic piece 3, the reed 2 is reset, thereby achieving the reuse of the overheat protector such that the high cost caused by the replacement of the conventional fuse protector is avoided.

The first power connection end 11 and the holder 41 are riveted to a first end of the base 1 through a first rivet 13, and a second end of the base 1 is provided with a stationary contact 14. The stationary contact 14 and the second power connection end 12 are riveted by a second rivet 15, and the second end of the reed 2 is provided with a movable contact 22. The movable contact 22 and the stationary contact 14 are arranged up and down in a paired manner. Normally, the second end of the reed 2 is provided with a bent protrusion for ensuring the electrical connection between the reed 2 and the second power connection end 12. Preferably, the stationary contact 14 is riveted on the second rivet 15, and the movable contact 22 is arranged on the reed 2. The movable contact 22 and the stationary contact 14 interact to make the electrical connection more stable and avoid the arcing phenomenon.

Preferably, the overheat protector comprises a housing. The housing 16 covers a bottom surface, a left end surface, a right end surface, a front side surface and a rear side surface of the base 1. An upper end of the housing 16 is provided with an opening, and the first power connection end 11 and the second power connection end 12 respectively penetrate through a left end wall and a right end wall of the housing 16. The housing 16 ensures the electrical safety of each component on the base 1. Preferably, the upper end of the housing 16 is provided with the opening, making an additional heat conduction element for the temperature sensing piece 21 unnecessary. Thus, the temperature sensing piece 21 is more sensitive to the temperature variation, and the thermal sensitivity is significantly improved.

### Embodiment 2

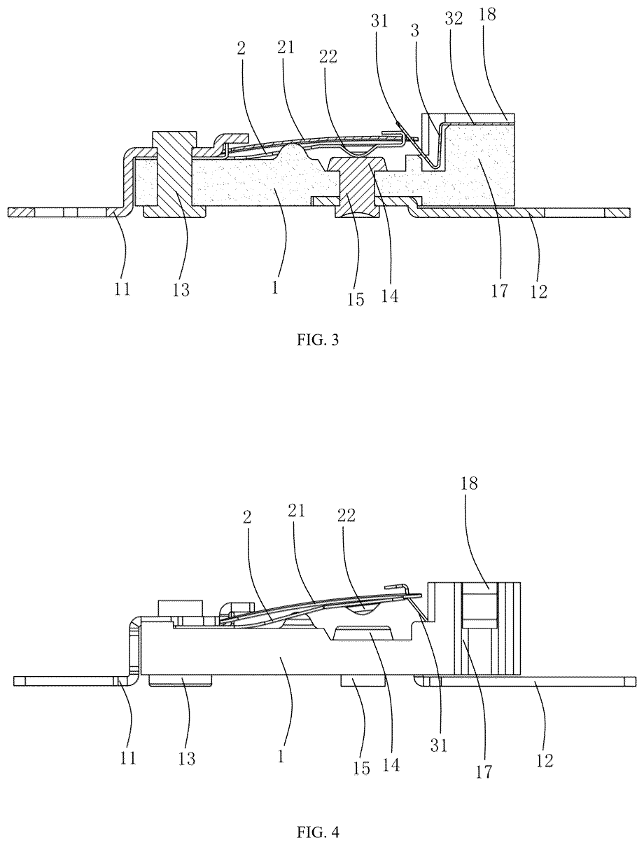

Referring to FIGS. 3-4, the difference between embodiment 2 and Embodiment 1 is that the first end of the anti-reset elastic piece 3 is provided with the fixing member 32, the second end of the base 1 is provided with a socket 17, and the socket 17 is provided with a fastener 18 connected to the socket 17 in a paired manner. The fixing member is arranged between the fastener 18 and the socket 17 in a penetrating manner, and the fastener 18 is connected to the socket 17 in a paired manner for fixing the anti-reset elastic piece 3 on the socket 17.

The above are merely the preferred embodiments of the present invention, and therefore any equivalent changes or modifications made according to the structures, features and principles described within the scope of the present invention shall all fall into the scope defined by the claims of the present invention.

What is claimed is:

1. An anti-reset overheat protector, comprising:
a base 1, wherein the base (1) is provided with a first power connection end (11), a second power connection end (12), a reed (2) and a temperature sensing piece (21), wherein a first end of the reed (2) is fixedly connected to the first power connection end (11), wherein a second end of the reed (2) is paired with the second power connection end (12), wherein the temperature sensing piece (21) is arranged above the reed (2), wherein a first end of the temperature sensing piece (21) is connected to the first power connection end (11) in an interacting mode, wherein a second end of the temperature sensing piece (21) is connected to the second end of the reed (2) in an interacting mode, wherein an anti-reset structure is arranged on the base (1), and wherein the anti-reset structure is connected to the second end of the reed (2) in an interacting mode.

2. The anti-reset overheat protector of claim 1, wherein the anti-reset structure comprises:
an anti-reset elastic piece (3), wherein the anti-reset elastic piece (3) is arranged on one side of the second end of the temperature sensing piece (21), wherein a first end of the anti-reset elastic piece (3) is fixedly connected to the base (1), wherein a second end of the anti-reset elastic piece (3) is provided with a limiting hook (31), wherein the second end of the reed (2) abuts against the limiting hook (31), and wherein when the temperature sensing piece (21) deforms, the limiting hook (31) is propelled to move towards the anti-reset elastic piece (3), so that the second end of the reed (2) goes over the limiting hook (31) and is hooked on the limiting hook (31).

3. The anti-reset overheat protector of claim 2, wherein the limiting hook (31) and the anti-reset elastic piece (3) are configured to be an integrally-bent structure, wherein the limiting hook (31) and the anti-reset elastic piece (3) form a V-shaped deformable structure, and wherein when the temperature sensing piece (21) deforms, the limiting hook (31) is propelled to deform towards the anti-reset elastic piece (3), so that the second end of the reed (2) is hooked on the limiting hook (31).

4. The anti-reset overheat protector of claim 3, wherein the base (1) is provided with a support plate (4), wherein the support plate (4) is arranged opposite to the second end of the reed (2), and wherein the anti-reset elastic piece (3) is attached to the support plate (4), so that the limiting hook (31) and the reed (2) are connected in an interacting mode.

5. The anti-reset overheat protector of claim 4, wherein the overheat protector comprises:
a holder (41), wherein a first end of the holder (41) is fixedly connected to the base (1), wherein the holder 41 is arranged above the temperature sensing piece (21), wherein a second end of the holder (41) is fixedly connected to the support plate (4), wherein the first end of the anti-reset elastic piece (3) is provided with a fixing member (32), and wherein the fixing member (32) is fixedly connected to the holder (41), thereby allowing the anti-reset elastic piece (3) to be attached to the support plate (4).

6. The anti-reset overheat protector of claim 5, wherein the holder (41) is provided with a hollowed-out groove (42).

7. The anti-reset overheat protector of claim 5, wherein the overheat protector further comprises:
a special tool (5), wherein a connecting portion between the support plate (4) and the holder (41) is provided with a reset groove (43), and wherein the special tool (5) is capable of penetrating through the reset groove (43) to pull the limiting hook (31) to move towards the anti-reset elastic piece (3).

8. The anti-reset overheat protector of claim 1, wherein the first power connection end (11) and the holder (41) are riveted to a first end of the base (1) through a first rivet (13), wherein a second end of the base (1) is provided with a stationary contact (14), wherein the stationary contact (14) and the second power connection end (12) are riveted by a second rivet (15), wherein the second end of the reed (2) is provided with a movable contact (22), and wherein the movable contact (22) and the stationary contact (14) are arranged up and down in a paired manner.

9. The anti-reset overheat protector of claim 1, wherein the overheat protector comprises:
a housing, wherein the housing (16) covers a bottom surface, a left end surface, a right end surface, a front side surface and a rear side surface of the base (1), wherein an upper end of the housing (16) is provided with an opening, and wherein the first power connection end (11) and the second power connection end (12) respectively penetrate through a left end wall and a right end wall of the housing (16).

10. The anti-reset overheat protector of claim 3, wherein the first end of the anti-reset elastic piece (3) is provided with the fixing member (32), wherein the second end of the base (1) is provided with a socket (17), wherein the socket (17) is provided with a fastener (18) connected to the socket (17) in a paired manner, wherein the fixing member is arranged between the fastener (18) and the socket (17) in a penetrating manner, and wherein the fastener (18) is connected to the socket (17) in a paired manner for fixing the anti-reset elastic piece 3 on the socket (17).
